(19) United States
(12) Patent Application Publication
(10) Pub. No.: US 2017/0338617 A1
(43) Pub. Date: Nov. 23, 2017

(54) SOLID-STATE LASER APPARATUS, FIBER AMPLIFIER SYSTEM, AND SOLID-STATE LASER SYSTEM

(71) Applicants: The University of Tokyo, Tokyo (JP); GIGAPHOTON INC., Tochigi (JP)

(72) Inventors: Zhigang ZHAO, Tokyo (JP); Yohei KOBAYASHI, Tokyo (JP); Shinji ITO, Tochigi (JP); Osamu WAKABAYASHI, Tochigi (JP)

(73) Assignees: The University of Tokyo, Tokyo (JP); GIGAPHOTON INC., Tochigi (JP)

(21) Appl. No.: 15/672,542

(22) Filed: Aug. 9, 2017

Related U.S. Application Data
(63) Continuation of application No. PCT/JP2015/057033, filed on Mar. 10, 2015.

(51) Int. Cl. H01S 3/067; H01S 3/10

(52) U.S. Cl. CPC H01S 3/06754; H01S 3/06716; H01S 3/10015

(57) ABSTRACT

A solid-state laser apparatus may include a first oscillator, a laser light generator, and a plurality of stages of fiber amplifiers. The first oscillator may be configured to output seed light. The laser light generator may be configured to output a pulsed laser light beam generated on a basis of the seed light. The plurality of stages of fiber amplifiers may be disposed in series in an optical path of the pulsed laser light beam, and may include a final stage fiber amplifier. The final stage fiber amplifier may be located in a final stage in the plurality of stages of fiber amplifiers, and may include a silica fiber doped with erbium and ytterbium. A value as a result of division of a cross-sectional area of the silica fiber by a fiber length of the silica fiber may be in a range from 0.7 nm to 1.64 nm both inclusive.

### CROSS REFERENCE TO RELATED APPLICATIONS

The present application is a continuation application of International Application No. PCT/JP2015/057033 filed on Mar. 10, 2015. The content of the application is incorporated herein by reference in its entirety.

### BACKGROUND

### 1. Technical Field

The present disclosure relates to a solid-state laser apparatus that generates a pulsed laser light beam, a fiber amplifier system, and a solid-state laser system.

### 2. Related Art

With miniaturization and high integration of a semiconductor integrated circuit, an improvement in resolution has been demanded for a semiconductor exposure apparatus. Hereinafter, the semiconductor exposure apparatus is simply referred to as an “exposure apparatus”. Shortening in a wavelength of light to be outputted from an exposure light source has been in progress accordingly. A gas laser unit is used in place of an existing mercury lamp for the exposure light source. Currently, a KrF excimer laser unit and an ArF excimer laser unit may be used as gas laser units for exposure. The KrF excimer laser unit may output ultraviolet light with a wavelength of 248 nm, and the ArF excimer laser unit may output ultraviolet light with a wavelength of 193 nm.

As current exposure technology, liquid immersion exposure is practically used. In the liquid immersion exposure, a clearance between a projection lens on exposure apparatus side and a wafer is filled with a liquid to change a refractive index of the clearance, thereby shortening an apparent wavelength of light from the exposure light source. When the liquid immersion exposure is performed with use of the ArF excimer laser unit as the exposure light source, ultraviolet light with a wavelength of 134 nm in water is applied to the wafer. This technology is referred to as “ArF liquid immersion exposure”. The ArF liquid immersion exposure is also referred to as “ArF liquid immersion lithography”.

Since a spectral line width in free oscillation of each of the KrF excimer laser unit and the ArF excimer laser unit is wide, e.g., in a range from about 350 μm to about 400 μm, color aberration of laser light (ultraviolet light) that is reduced and projected on the wafer by the projection lens on the exposure apparatus side occurs, which results in decrease in resolution. It is therefore necessary to narrow a spectral line width of laser light to be outputted from the gas laser unit to an extent in which the color aberration is negligible. The spectral line width is also referred to as “spectral width”. Accordingly, a line narrow module including a line narrowing device is provided in a laser resonator of the gas laser unit, which achieves narrowing of the spectral width. Non-limiting examples of the line narrowing device may include an etalon and a grating. The laser unit narrowed in spectral width in this way is referred to as “line narrowing laser unit”. For example, reference is made to U.S. Pat. No. 7,593,437, U.S. Pat. No. 6,611,372, Japanese Unexamined Patent Application Publication No. 2013-222173, U.S. Patent Application Publication No. 2013/0279526, Japanese Patent No. 4925085, and Peng Wan, et al. “Low repetition rate high energy 1.5 μm fiber laser”, 12 Sep. 2011/Vol. 19, No. 19/OPTICS EXPRESS 18067.

### SUMMARY

A solid-state laser apparatus according to an aspect of the present disclosure may include a first oscillator, a laser light generator, and a plurality of stages of fiber amplifiers. The first oscillator may be configured to output seed light. The laser light generator may be configured to output a pulsed laser light beam generated on a basis of the seed light. The plurality of stages of fiber amplifiers may be disposed in series in an optical path of the pulsed laser light beam, and may include a final stage fiber amplifier. The final stage fiber amplifier may be located in a final stage in the plurality of stages of fiber amplifiers, and may include a silica fiber doped with erbium and ytterbium. A value as a result of division of a cross-sectional area of the silica fiber by a fiber length of the silica fiber may be in a range from 0.7 nm to 1.64 nm both inclusive.

A fiber amplifier system according to an aspect of the present disclosure may include an optical device, a first fiber amplifier, and a second fiber amplifier. The optical device may be configured to cause a first optical path of a pulsed laser light beam to be branched into a second optical path and a third optical path. The first fiber amplifier may be disposed in the second optical path. The second fiber amplifier may be disposed in the third optical path.

A solid-state laser system according to an aspect of the present disclosure may include a first solid-state laser unit, a second solid-state laser unit, a first wavelength converter, and a second wavelength converter. The first solid-state laser unit may be configured to output a first pulsed laser light beam with a first wavelength. The second solid-state laser unit may include a first plurality of stages of fiber amplifiers and a second plurality of stages of fiber amplifiers. The first plurality of stages of fiber amplifiers may be disposed in series, and may be configured to output a second pulsed laser light beam with a second wavelength, and the second plurality of stages of fiber amplifiers may be disposed in series, and may be configured to output a third pulsed laser light beam with the second wavelength. The first wavelength converter may be configured to receive the first pulsed laser light beam and the second pulsed laser light beam, and may output a fourth pulsed laser light beam with a third wavelength that is converted from the first wavelength and the second wavelength. The second wavelength converter may be configured to receive the third pulsed laser light beam and the fourth pulsed laser light beam, and may output a fifth pulsed laser light beam with a fourth wavelength that is converted from the second wavelength and the third wavelength.

### BRIEF DESCRIPTION OF THE DRAWINGS

Some example embodiments of the present disclosure are described below as mere examples with reference to the accompanying drawings.

FIG. 1 is a configuration diagram schematically illustrating a configuration example of a laser apparatus that is used for an exposure apparatus and includes a solid-state laser apparatus according to a comparative example.

FIG. 2 is a configuration diagram schematically illustrating a configuration example of an amplifier illustrated in FIG. 1.

FIG. 3 is a configuration diagram schematically illustrating a configuration example of a second solid-state laser unit according to a first embodiment.

FIG. 4 is an explanatory diagram illustrating a characteristic example of an Er fiber amplifier.

FIG. 5 is a configuration diagram illustrating a configuration example of an Er fiber amplifier in a final stage according to a first modification example of the first embodiment.

FIG. 6 is a configuration diagram illustrating a configuration example of another Er fiber amplifier in the final stage according to the first modification example of the first embodiment.

FIG. 7 is a configuration diagram illustrating a configuration example of an Er fiber amplifier in a final stage according to a second modification example of the first embodiment.

FIG. 8 is a configuration diagram illustrating a configuration example of another Er fiber amplifier in the final stage according to the second modification example of the first embodiment.

FIG. 9 is a configuration diagram schematically illustrating a configuration example of an amplifier according to a fourth modification example of the first embodiment.

FIG. 10 is a configuration diagram schematically illustrating a configuration example of a solid-state laser system according to a second embodiment.

FIG. 11 is a configuration diagram illustrating a configuration example of an Er fiber amplifier system illustrated in FIG. 10.

FIG. 12 is a configuration diagram schematically illustrating a configuration example of a solid-state laser system according to a first modification example of the second embodiment.

FIG. 13 is a configuration diagram schematically illustrating a configuration example of an Er fiber amplifier system illustrated in FIG. 12.

FIG. 14 is a configuration diagram schematically illustrating a configuration example of a solid-state laser system according to a second modification example of the second embodiment.

FIG. 15 illustrates an example of a hardware environment of a controller.

### DETAILED DESCRIPTION

### <Contents>

### [1. Overview]

[2. Comparative Example] (Laser apparatus that is used for an exposure apparatus and includes a solid-state laser apparatus)

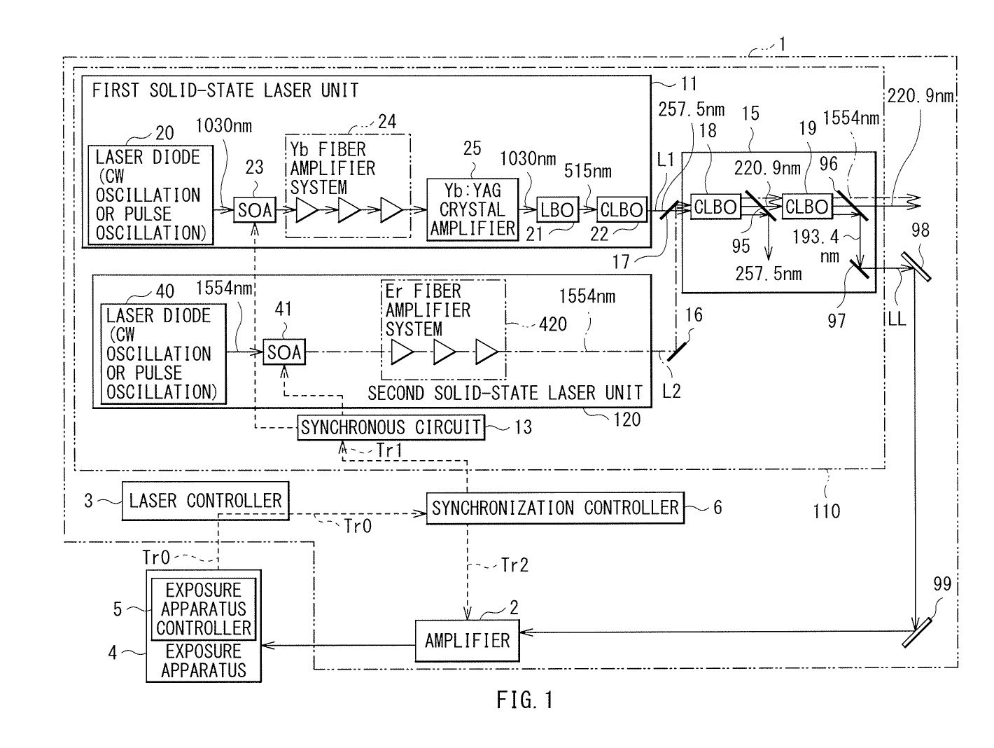

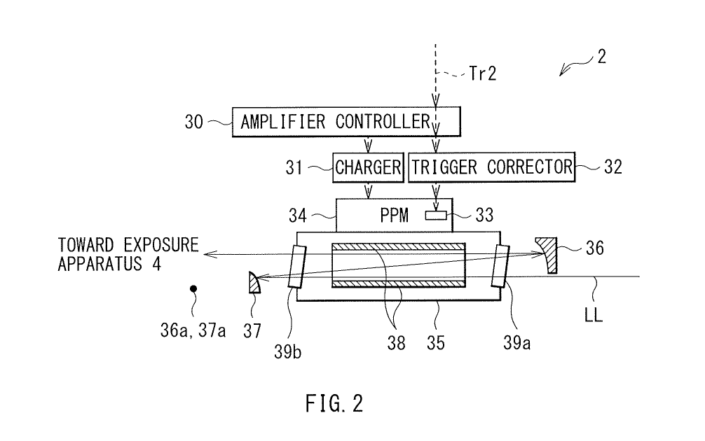

2.1 Configuration (FIGS. 1 and 2)

2.2 Operation

2.3 Issues

[3. First Embodiment] (Second solid-state laser unit)

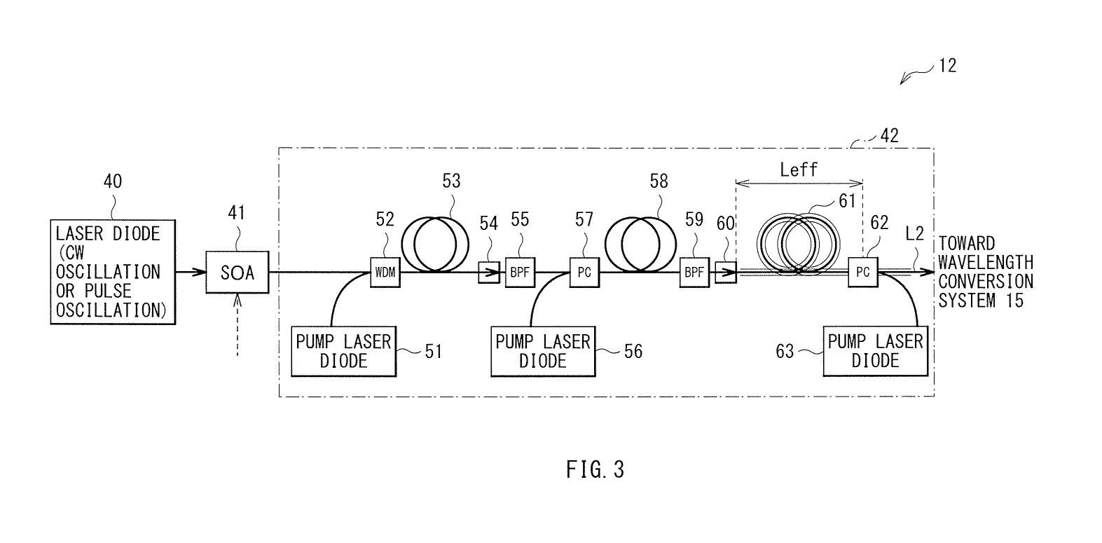

3.1 Configuration (FIG. 3)

3.2 Operation

3.3 Workings

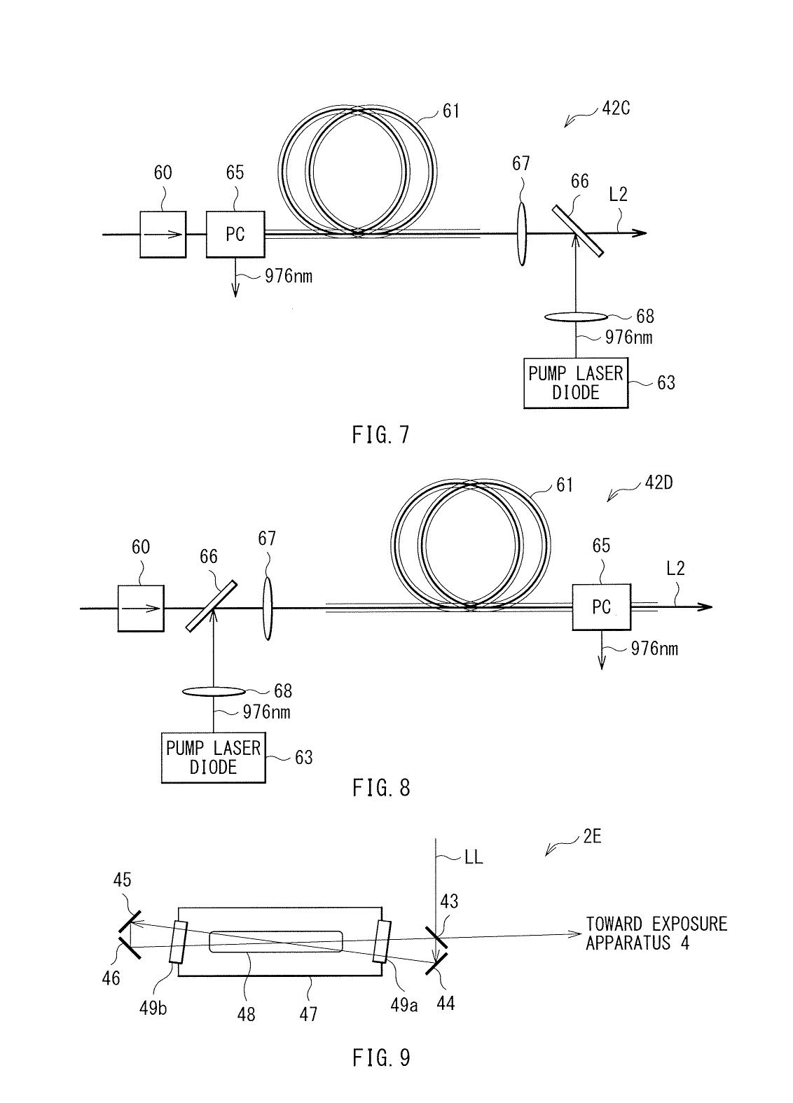

3.4 Modification Examples
3.4.1 First Modification Example (FIGS. 5 and 6)
3.4.2 Second Modification Example (FIGS. 7 and 8)
3.4.3 Third Modification Example
3.4.4 Fourth Modification Example (FIG. 9)
   [4. Second Embodiment] (Solid-state laser system)

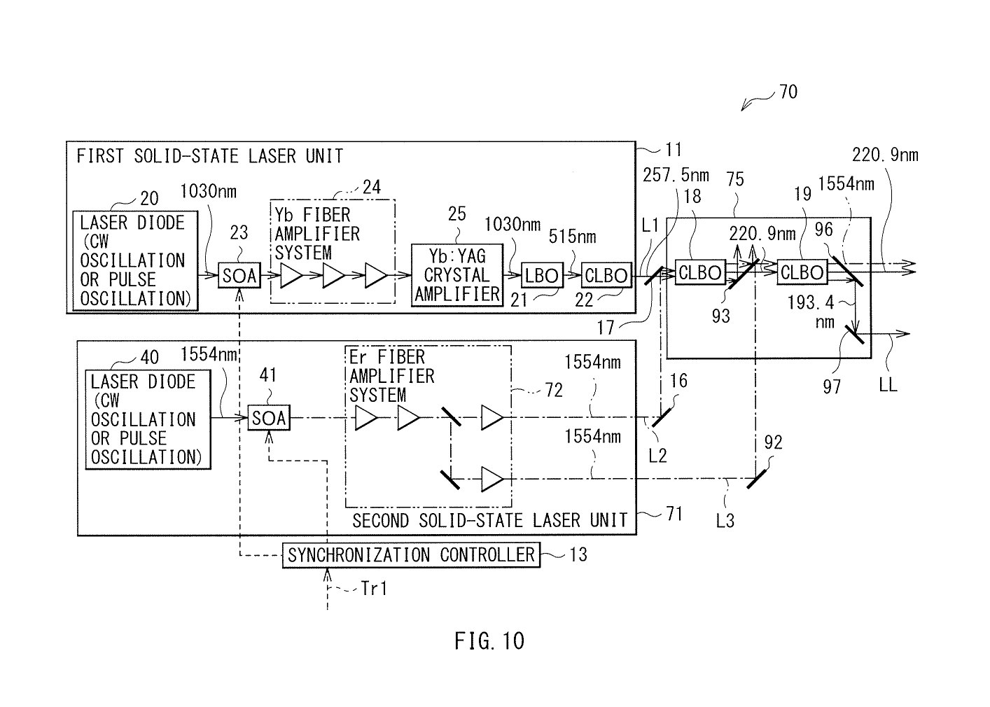

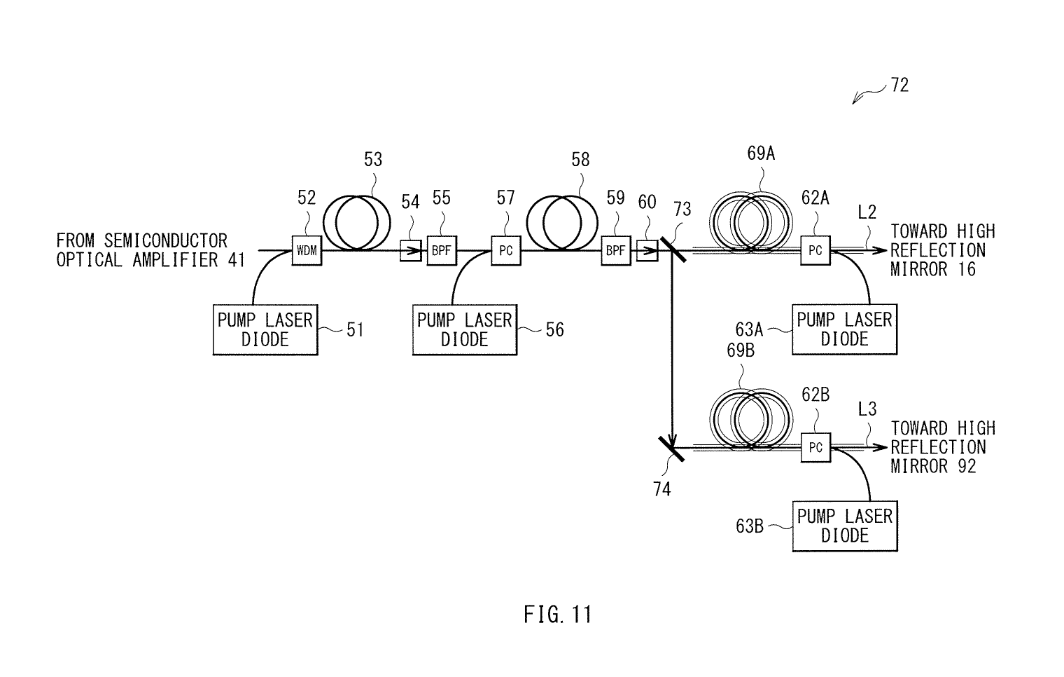

4.1 Configuration (FIGS. 10 and 11)

4.2 Operation

4.3 Workings

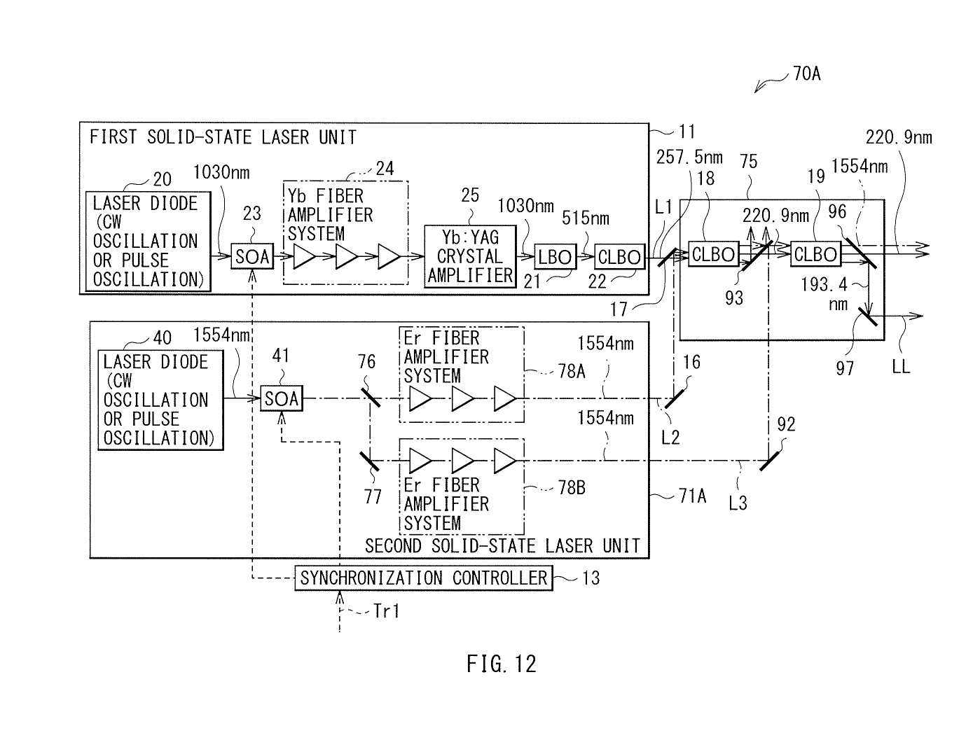

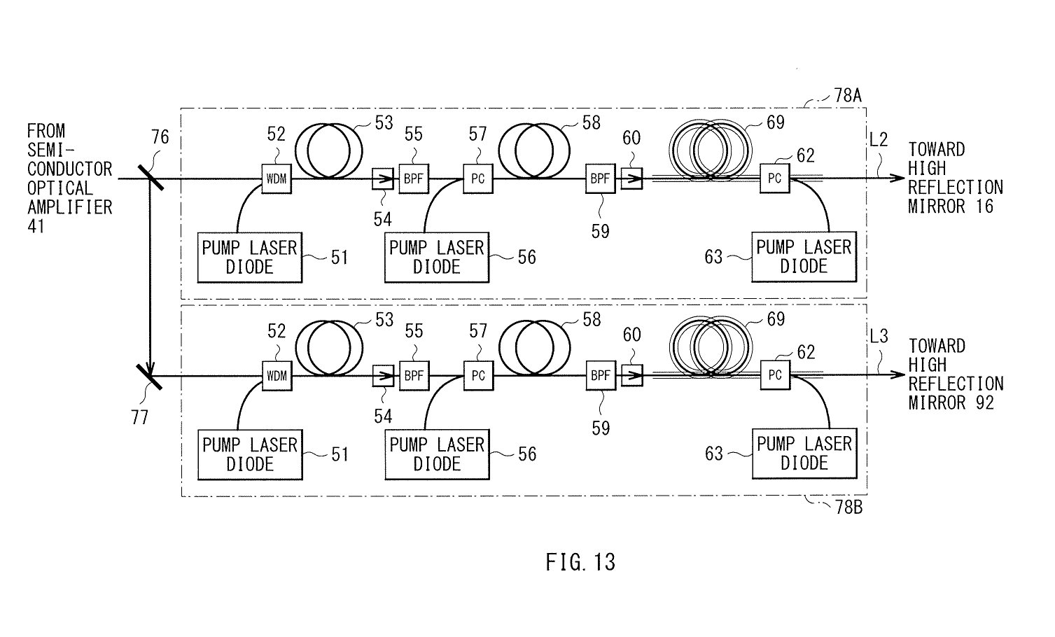

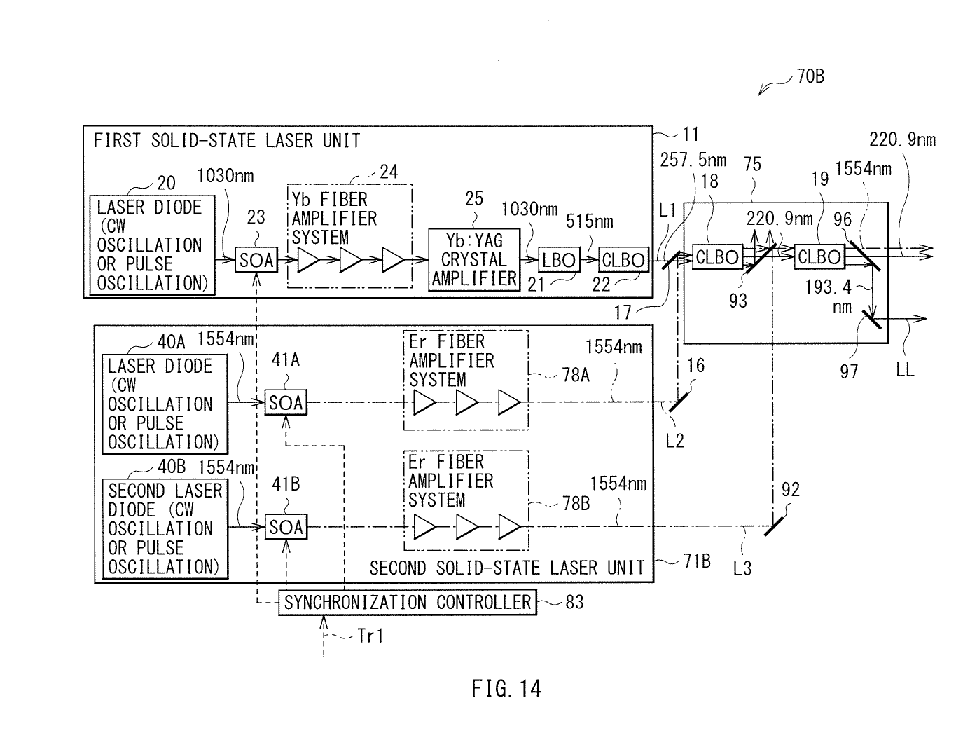

4.4 Modification Examples
4.4.1 First Modification Example (FIGS. 12 and 13)
4.4.2 Second Modification Example (FIG. 14)

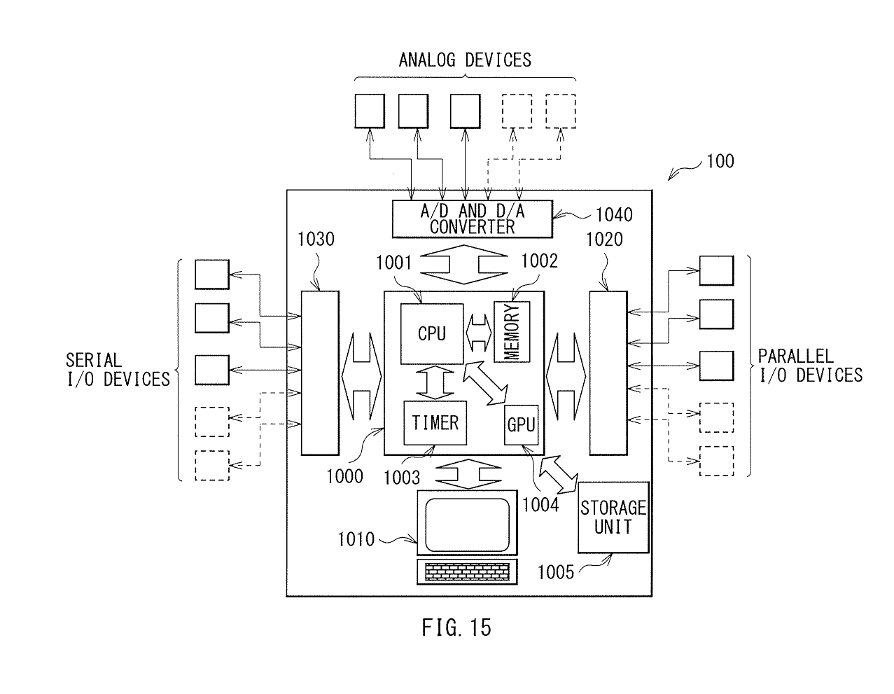

### [5. Hardware Environment of Controller] (FIG. 15)

### [6. Et Cetera]

In the following, some example embodiments of the present disclosure are described in detail with reference to the drawings. Example embodiments described below each illustrate one example of the present disclosure and are not intended to limit the contents of the present disclosure. Further, all of the configurations and operations described in each example embodiment are not necessarily essential for the configurations and operations of the present disclosure. Note that like components are denoted by like reference numerals, and redundant description thereof is omitted.

### 1. Overview

The present disclosure relates to a solid-state laser apparatus that generates, for example, a pulsed laser light beam, a fiber amplifier system, and a solid-state laser system.

### 2. Comparative Example

First, description is given of a laser apparatus that is used for an exposure apparatus and includes a solid-state laser unit according to a comparative example with respect to example embodiments of the present disclosure.

The laser apparatus used for the exposure apparatus may have a configuration including a master oscillator (MO) and a power oscillator (PO). In such a laser apparatus used for the exposure apparatus, an ArF laser unit using an ArF laser gas as a laser medium may be used for the MO and the PO. However, in term of energy saving, development of a laser apparatus that is used for an exposure apparatus and includes a solid-state laser system as an MO is in progress. The solid-state laser system may output a pulsed laser light beam with a wavelength of 193.4 nm. The MO may include a first solid-state laser unit, a second solid-state laser unit, and a wavelength conversion system. Each of the first solid-state laser unit and the second solid-state laser unit may include an ytterbium (Yb) fiber amplifier system and an erbium (Er) fiber amplifier system. In the following, description is given of a configuration example of such a laser apparatus used for the exposure apparatus.

### 2.1 Configuration

FIG. 1 schematically illustrates a configuration example of the laser apparatus used for the exposure apparatus according to the comparative example with respect to example embodiments of the present disclosure.

A laser apparatus 1 used for an exposure apparatus may include a solid-state laser system 110, an amplifier 2, a laser controller 3, a synchronization controller 6, and high reflection mirrors 98 and 99.

The solid-state laser system 110 may include a first solid-state laser unit 11, a second solid-state laser unit 120, a synchronous circuit 13, a high reflection mirror 16, a dichroic mirror 17, and a wavelength conversion system 15.

The first solid-state laser unit 11 may be configured to output a first pulsed laser light beam L1 with a first wavelength toward the wavelength conversion system 15 via the dichroic mirror 17. The first pulsed laser light beam L1 may be generated on the basis of seed light. The first wavelength may be about 257.5 nm. The first solid-state laser unit 11 may include a laser diode 20, a semiconductor optical amplifier (SOA) 23, an Yb fiber amplifier system 24, and an Yb:YAG crystal amplifier 25. The first solid-state laser unit 11 may further include a LBO (LiB₃O₅) crystal 21 and a CLBO (CsLiB₆O₁₀) crystal 22 that are nonlinear crystals. The laser diode 20, the semiconductor optical amplifier 23, the Yb fiber amplifier system 24, the Yb:YAG crystal amplifier 25, the LBO crystal 21, and the CLBO crystal 22 may be disposed in an optical path in this order from upstream to downstream.

The laser diode 20 may be a distributed-feedback laser diode that outputs seed light with a wavelength of about 1030 nm by CW oscillation or pulse oscillation. The laser diode 20 may be a single longitudinal mode laser diode that varies a wavelength around a wavelength of about 1030 nm.

The semiconductor optical amplifier 23 may be a semiconductor device that causes a pulse current to flow through a semiconductor, thereby converting the seed light into a pulsed laser light beam with a predetermined pulse width and amplifying the pulsed laser light beam. The semiconductor optical amplifier 23 may include an unillustrated current controller that causes the pulse current to flow through the semiconductor on the basis of an instruction from the synchronous circuit 13. The semiconductor optical amplifier 23 may be configured to operate in synchronization with the laser diode 20 in a case where the laser diode 20 oscillates in a pulse mode.

The Yb fiber amplifier system 24 may include a plurality of stages of optical fiber amplifiers and a CW excitation laser diode. The optical fiber amplifiers each may be doped with Yb. The CW excitation laser diode may output excited light by CW oscillation and supply the excited light to each of the optical fiber amplifiers.

The LBO crystal 21 may receive a pulsed laser light beam with a wavelength of about 1030 nm and output a pulsed laser light beam with a wavelength of about 515 nm. The CLBO crystal 22 may receive a pulsed laser light beam with a wavelength of about 515 nm and output a pulsed laser light beam with a wavelength of about 257.5 nm.

The second solid-state laser unit 120 may be configured to output a second pulsed laser light beam L2 with a second wavelength toward the wavelength conversion system 15 via the high reflection mirror 16 and the dichroic mirror 17. The second pulsed laser light beam L2 may be generated on the basis of seed light. The second wavelength may be about 1554 nm. The second solid-state laser unit 120 may include a laser diode 40, a semiconductor optical amplifier (SOA) 41, and an Er fiber amplifier system 420. The laser diode 40, the semiconductor optical amplifier 41, and the Er fiber amplifier system 420 may be disposed in an optical path in this order from upstream to downstream.

The laser diode 40 may be a distributed-feedback laser diode that outputs seed light with a wavelength of about 1554 nm by CW oscillation or pulse oscillation. The laser diode 40 may be a single longitudinal mode laser diode that varies a wavelength around a wavelength of about 1554 nm.

The semiconductor optical amplifier 41 may be a semiconductor device that causes a pulse current to flow through a semiconductor, thereby converting the seed light into a pulsed laser light beam with a predetermined pulse width and amplifying the pulsed laser light beam. The semiconductor optical amplifier 41 may include an unillustrated current controller that causes the pulse current to flow through the semiconductor on the basis of an instruction from the synchronous circuit 13. The semiconductor optical amplifier 41 may be configured to operate in synchronization with the laser diode 40 in a case where the laser diode oscillates in a pulse mode.

The Er fiber amplifier system 420 may include a plurality of stages of optical fiber amplifiers and a CW excitation laser diode. The optical fiber amplifiers each may be doped with both Er and Yb. The CW excitation laser diode may output excited light by CW oscillation and supply the excited light to each of the optical fiber amplifiers.

The synchronous circuit 13 may be configured to output a predetermined trigger signal to each of the semiconductor optical amplifier 23 of the first solid-state laser unit 11 and the semiconductor optical amplifier 41 of the second solid-state laser unit 120 on the basis of a trigger signal Tr1 from the synchronization controller 6.

The high reflection mirror 16 may be so disposed as to reflect the second pulsed laser light beam L2 outputted from the second solid-state laser unit 120 at high reflectivity, thereby allowing the reflected second pulsed laser light beam L2 to enter the dichroic mirror 17.

The dichroic mirror 17 may be configured of a substrate coated with a film that allows the first pulsed laser light beam L1 with the first wavelength to pass therethrough at high transmittance and reflects the second pulsed laser light beam L2 with the second wavelength at high reflectivity. The substrate may allow the first pulsed laser light beam L1 with the first wavelength to pass therethrough at high transmittance. The dichroic mirror 17 may be so disposed as to allow the first pulsed laser light beam L1 and the second pulsed laser light beam L2 to enter the wavelength conversion system 15 while optical path axes of the first and second pulsed laser light beams L1 and L2 are substantially coincident with each other.

The wavelength conversion system 15 may be configured to receive the first pulsed laser light beam L1 with the first wavelength and the second pulsed laser light beam L2 with the second wavelength and output a pulsed laser light beam LL with a wavelength different from the first wavelength and the second wavelength. The wavelength conversion system 15 may include CLBO crystals 18 and 19, dichroic mirrors 95 and 96, and a high reflection mirror 97. The CLBO crystal 18, the dichroic mirror 95, the CLBO crystal 19, and the dichroic mirror 96 may be disposed in an optical path in this order from upstream to downstream.

The first pulsed laser light beam L1 with a wavelength of about 257.5 nm and the second pulsed laser light beam L2 with a wavelength of about 1554 nm may enter the CLBO crystal 18. The CLBO crystal 18 may output a pulsed laser light beam with a wavelength of about 220.9 nm corresponding to a sum frequency of a wavelength of about 257.5 nm and a wavelength of about 1554 nm.

The dichroic mirror 95 may be coated with a film that allows a pulsed laser light beam with a wavelength of about 1554 nm and a pulsed laser light beam with a wavelength of about 220.9 nm to pass therethrough at high transmittance and reflects a pulsed laser light beam with a wavelength of about 257.5 nm at high reflectivity.

The pulsed laser light beam with a wavelength of about 1554 nm and the pulsed laser light beam with a wavelength of about 220.9 nm having passed through the dichroic mirror 95 may enter the CLBO crystal 19. The CLBO crystal 19 may output the pulsed laser light beam LL with a wavelength of about 193.4 nm corresponding to a sum frequency of a wavelength of about 1554 nm and a wavelength of about 220.9 nm.

The dichroic mirror 96 may be coated with a film that allows a pulsed laser light beam with a wavelength of about 1554 nm and a pulsed laser light beam with a wavelength of about 220.9 nm to pass therethrough at high transmittance and reflects the pulsed laser light beam LL with a wavelength of about 193.4 nm at high reflectivity.

The high reflection mirror 97 may be so disposed as to allow the solid-state laser system 110 to output the pulsed laser light beam LL with a wavelength of about 193.4 nm reflected by the dichroic mirror 96.

The high reflection mirrors 98 and 99 may be so disposed as to allow the pulsed laser light beam LL with a wavelength of about 193.4 nm outputted from the solid-state laser system 110 to enter the amplifier 2.

The amplifier 2 may be configured to amplify the pulsed laser light beam LL with a wavelength of about 193.4 nm outputted from the solid-state laser system 110 and output the thus-amplified pulsed laser light beam toward the exposure apparatus 4.

FIG. 2 schematically illustrates a configuration example of the amplifier 2. The amplifier 2 may include an amplifier controller 30, a charger 31, a trigger corrector 32, a pulsed power module (PPM) 34 including a switch 33, a chamber 35, a concave mirror 36, and a convex mirror 37.

The chamber 35 may be provided with windows 39a and 39b. The chamber 35 may contain, for example, a laser gas containing an Ar gas, a F₂ gas, and a Ne gas. A pair of discharge electrodes 38 may be provided inside the chamber 35. The pair of discharge electrodes 38 may be coupled to an output terminal of the pulsed power module 34. The concave mirror 36 and the convex mirror 37 may be configured so that a focal position 36a of the concave mirror 36 is substantially coincident with a focal position 37a of the convex mirror 37.

The laser controller 3 may be coupled to the laser diode 20, the laser diode 40, the CW excitation laser diode in the Yb fiber amplifier system 24, and the CW excitation laser diode in the Er fiber amplifier system 420 through unillustrated signal lines.

The synchronization controller 6 may be supplied with an oscillation trigger signal Tr0 from the exposure apparatus 4 as an external apparatus via the laser controller 3, as illustrated in FIG. 1. The oscillation trigger signal Tr0 may indicate a timing of generating a pulsed laser light beam in the solid-state laser system 110. The exposure apparatus 4 may include an exposure apparatus controller 5. The exposure apparatus controller 5 of the exposure apparatus 4 may supply the oscillation trigger signal Tr0. The synchronization controller 6 may be configured to generate the trigger signal Tr1 on the basis of the oscillation trigger signal Tr0 and supply the thus-generated trigger signal Tr1 to the synchronous circuit 13. Moreover, the synchronization controller 6 may be configured to generate a trigger signal Tr2 on the basis of the oscillation trigger signal Tr0 and supply the thus-generated trigger signal Tr2 to the trigger corrector 32 via the amplifier controller 30, as illustrated in FIG. 2.

### 2.2 Operation

The laser controller 3 may cause the laser diodes 20 and 40 to oscillate in a CW mode or in a pulse mode on the basis of the oscillation trigger signal Tr0. Moreover, the laser controller 3 may cause the CW excitation laser diode in the Yb fiber amplifier system 24 and the CW excitation laser diode in the Er fiber amplifier system 420 to oscillate in the CW mode on the basis of the oscillation trigger signal Tr0.

The synchronization controller 6 may control a delay time between the oscillation trigger signal Tr0 and the trigger signal Tr1 and a delay time between the oscillation trigger signal Tr0 and the trigger signal Tr2 upon reception of the oscillation trigger signal Tr0 from the exposure apparatus controller 5 via the laser controller 3. The delay times may be so controlled as to cause the pair of discharge electrodes 38 to be discharged in synchronization with entry of the pulsed laser light beam LL outputted from the solid-state laser system 110 to the amplifier 2.

In the first solid-state laser unit 11, the first laser diode 20 may output CW-oscillated light or pulse-oscillated light with a wavelength of about 1030 nm as the seed light. The semiconductor optical amplifier 23 may convert the seed light into a pulsed laser light beam with a predetermined pulse width on the basis of a predetermined trigger signal from the synchronous circuit 13 and amplify the pulsed laser light beam. The pulsed laser light beam outputted from the semiconductor optical amplifier 23 may enter the Yb fiber amplifier system 24, and may be amplified by the Yb fiber amplifier system 24. The pulsed laser light beam outputted from the Yb fiber amplifier system 24 may enter the Yb:YAG crystal amplifier 25, and may be amplified by the Yb:YAG crystal amplifier 25. The pulsed laser light beam outputted from the Yb:YAG crystal amplifier 25 may enter the LBO crystal 21. Thereafter, the LBO crystal 21 and the CLBO crystal 22 may generate a fourth harmonic with a wavelength of about 257.5 nm from the pulsed laser light beam. Thus, the first solid-state laser unit 11 may output the first pulsed laser light beam L1 with a wavelength of about 257.5 nm.

In contrast, in the second solid-state laser unit 120, the laser diode 40 may output CW-oscillated light or pulse-oscillated light with a wavelength of about 1554 nm as the seed light. The semiconductor optical amplifier 41 may convert the seed light into a pulsed laser light beam with a predetermined pulse width on the basis of the predetermined trigger signal from the synchronous circuit 13 and amplify the pulsed laser light beam. The pulsed laser light beam outputted from the semiconductor optical amplifier 41 may enter the Er fiber amplifier system 420, and may be amplified by the Er fiber amplifier system 420. Thus, the second solid-state laser unit 120 may output the second pulsed laser light beam L2 with a wavelength of about 1554 nm.

The first pulsed laser light beam L1 with a wavelength of about 257.5 nm outputted from the first solid-state laser unit 11 may enter the wavelength conversion system 15 via the dichroic mirror 17. Moreover, the second pulsed laser light beam L2 with a wavelength of about 1554 nm outputted from the second solid-state laser unit 120 may enter the wavelength conversion system 15 via the high reflection mirror 16 and the dichroic mirror 17.

At this occasion, the synchronous circuit 13 may supply a trigger signal with a predetermined pulse width at a predetermined timing to each of the semiconductor optical amplifiers 23 and 41 on the basis of the trigger signal Tr1. The predetermined timing may be so adjusted as to allow the first pulsed laser light beam L1 and the second pulsed laser light beam L2 to enter the CLBO crystal 18 of the wavelength conversion system 15 at a substantially coincidental timing. The pulse width of the trigger signal to be supplied to the semiconductor optical amplifier 23 may be so adjusted as to allow the pulse width of the first pulsed laser light beam L1 to fall in a range from 1 nsec to 30 nsec both inclusive. The pulse width of the trigger signal to be supplied to the semiconductor optical amplifier 41 may be so adjusted as to allow the pulse width of the second pulsed laser light beam L2 to fall in a range from 1 nsec to 30 nsec both inclusive. Accordingly, the pulse width of the pulsed laser light beam LL to be outputted from the solid-state laser system 110 may be so adjusted as to fall in a range from 1 nsec to 30 nsec both inclusive.

In the wavelength conversion system 15, the dichroic mirror 17 may cause the first pulsed laser light beam L1 and the second pulsed laser light beam L2 to enter the CLBO crystal 18 at a substantially coincidental timing and be superimposed on each other on the CLBO crystal 18. The CLBO crystal 18 may generate a pulsed laser light beam with a wavelength of about 220.9 nm corresponding to a sum frequency of a wavelength of about 257.5 nm and a wavelength of about 1554 nm. The CLBO crystal 18 may output three pulsed laser light beams, i.e., a pulsed laser light beam with a wavelength of about 257.5 nm, a pulsed laser light beam with a wavelength of about 1554 nm, and a pulsed laser light beam with a wavelength of about 220.9 nm.

The dichroic mirror 95 may allow a pulsed laser light beam with a wavelength of about 1554 nm and a pulsed laser light beam with a wavelength of about 220.9 nm of three pulsed laser light beams outputted from the CLBO crystal 18 to pass therethrough at high transmittance and may reflect a pulsed laser light beam with a wavelength of about 257.5 nm at high reflectivity. The two pulsed laser light beams having passed through the dichroic mirror 95 may enter the CLBO crystal 19.

The CLBO crystal 19 may generate the pulsed laser light beam LL with a wavelength of about 193.4 nm corresponding to a sum frequency of a wavelength of about 220.9 nm and a wavelength of about 1554 nm. The CLBO crystal 19 may output three pulsed laser light beams, i.e., a pulsed laser light beam with a wavelength of about 1554 nm, a pulsed laser light beam with a wavelength of about 220.9 nm, and a pulsed laser light beam with a wavelength of about 193.4 nm.

The dichroic mirror 96 may allow the pulsed laser light beam with a wavelength of about 1554 nm and the pulsed laser light beam with a wavelength of about 220.9 nm of the three pulsed laser light beams outputted from the CLBO crystal 19 to pass therethrough at high transmittance, and may reflect the pulsed laser light beam LL with a wavelength of about 193.4 nm at high reflectivity. The pulsed laser light beam LL with a wavelength of about 193.4 nm may be outputted from the wavelength conversion system 15 via the high reflection mirror 97. The pulsed laser light beam LL outputted from the wavelength conversion system 15 may enter the amplifier 2 via the high reflection mirrors 98 and 99.

The amplifier 2 may cause discharge by the pair of discharge electrodes 38 to produce a population inversion in synchronization with entry of the pulsed laser light beam LL. At this occasion, the trigger corrector 32 may adjust a timing of the switch 33 of the pulsed power module 34 so as to efficiently amplify, in the amplifier 2, the pulsed laser light beam LL with a wavelength of about 193.4 nm from the solid-state laser system 110. In the amplifier 2, the pulsed laser light beam LL may be reflected by the convex mirror 37 and the concave mirror 36 to pass through a discharge clearance between the pair of discharge electrodes 38 three times. Accordingly, the pulsed laser light beam LL may be enlarged and amplified. As described above, the pulsed laser light beam LL with a wavelength of about 193.4 nm outputted from the solid-state laser system 110 may be amplified by the amplifier 2, and may be outputted toward the exposure apparatus 4.

### 2.3 Issues

In the laser apparatus 1 used for the exposure apparatus, the following specifications of the solid-state laser system 110 may be demanded in a case where the MO is configured of the solid-state laser system 110.

Repetition frequency≦6 kHz
Pulse energy≧33 μJ/pulse (0.2 W at 6 kHz)
Spectral line width Δv≦4 GHz (0.50 pm at 193.4 nm) (full width at half maximum)
Pulse width from 1 ns to 30 ns (full width at half maximum)

In order to achieve such target specifications, the following target specifications of the second solid-state laser unit 120 may be demanded.

Repetition frequency≦6 kHz
Pulse energy≧167 μJ/pulse (1 W at 6 kHz)
Spectral line width Δv≦4 GHz (32.2 pm at 1554 nm) (full width at half maximum)
Pulse width from 1 ns to 30 ns (full width at half maximum)

Achieving such target specifications may result in stimulated brillouin scattering (SBS) in an optical fiber amplifier in a final stage in the Er fiber amplifier system 420. The SBS is a nonlinear phenomenon in a fiber. This may prevent amplification of the pulsed laser light beam in the optical fiber amplifier in the final stage, and may scatter the pulsed laser light beam to produce return light. In this case, the laser diode 40 may be damaged.

### 3. First Embodiment

Next, description is given of a solid-state laser apparatus according to a first embodiment of the present disclosure. Note that substantially same components as the components of the second solid-state laser unit 120 according to the foregoing comparative example illustrated in FIG. 1 are denoted by same reference numerals, and redundant description thereof is omitted.

### 3.1 Configuration

FIG. 3 schematically illustrates a configuration example of a second solid-state laser unit 12. The second solid-state laser unit 12 may include an Er fiber amplifier system 42 in place of the Er fiber amplifier system 420 in the configuration of the comparative example illustrated in FIG. 1.

The Er fiber amplifier system 42 may include Er fiber amplifiers 53, 58, and 61, isolators 54 and 60, and band-pass filters (BPFs) 55 and 59. The Er fiber amplifier 53, the isolator 54, the band-pass filter 55, the Er fiber amplifier 58, the band-pass filter 59, the isolator 60, and the Er fiber amplifier 61 may be disposed in an optical path in this order from upstream to downstream. The Er fiber amplifier system 42 may further include pump laser diodes 51, 56, and 63, a wavelength division multiplexer (WDM) optical coupler 52, and pump combiners (PCs) 57 and 62. The Er fiber amplifier 53 and the Er fiber amplifier 58 may be coupled to each other while remaining in a fiber form, or may be coupled to each other via air. Likewise, the Er fiber amplifier 58 and the Er fiber amplifier 61 may be coupled to each other while remaining in the fiber form or may be coupled to each other via air.

The Er fiber amplifier 53 may include a single mode fiber (SMF) that is a silica fiber doped with both Er and Yb. A fiber diameter of the single mode fiber may be about 6 μm. The Er fiber amplifier 53 may be coupled to an optical fiber coupled to the pump laser diode 51 on upstream side by the WDM optical coupler 52. The WDM optical coupler 52 may be configured to couple a pulsed laser light beam with a wavelength of about 1554 nm outputted from the semiconductor optical amplifier 41 and pumping light with a wavelength of about 976 nm outputted from the pump laser diode 51 together.

Each of the isolators 54 and 60 may be a Faraday isolator to prevent passage of return light, for example.

Each of the band-pass filters 55 and 59 may be configured of a glass substrate coated with a filter that allows a pulsed laser light beam with a wavelength of 1554 nm to pass therethrough at high transmittance and prevents passage of light other than the pulsed laser light beam with a wavelength of 1554 nm. The other light may include amplified spontaneous emission (ASE) and pumping light.

The Er fiber amplifier 58 may include a double-clad fiber (DCF) that is a silica fiber doped with both Er and Yb. A fiber diameter of the double-clad fiber may be about 10 μm. The Er fiber amplifier 58 may be coupled to an optical fiber coupled to the pump laser diode 56 on upstream side by the pump combiner 57. The pump combiner 57 may be configured to couple a pulsed laser light beam with a wavelength of about 1554 nm outputted from the Er fiber amplifier 53 previous to the pump combiner 57 and pumping light with a wavelength of about 976 nm outputted from the pump laser diode 56 together.

The Er fiber amplifier 61 may include a double-clad fiber (DCF) that is a silica fiber doped with both Er and Yb. The double-clad fiber may be a large mode area (LMA) fiber having a fiber diameter of about 25 μm. The fiber diameter of “about 25 μm” used herein may encompass manufacturing variations, for example. The double-clad fiber may be rolled so as to allow characteristics thereof to approach characteristics of a single transverse mode fiber. The Er fiber amplifier 61 may be coupled to an optical fiber coupled to the pump laser diode 63 on downstream side by the pump combiner 62. The pump combiner 62 may be configured to supply pumping light with a wavelength of about 976 nm outputted from the pump laser diode 63 to the Er fiber amplifier 61. An effective amplification fiber length Leff of the Er fiber amplifier 61 may be in a range from 0.3 m to 0.7 m both inclusive. Here, the effective amplification fiber length Leff represents a length of a portion where the pumping light passes of the Er fiber amplifier 61.

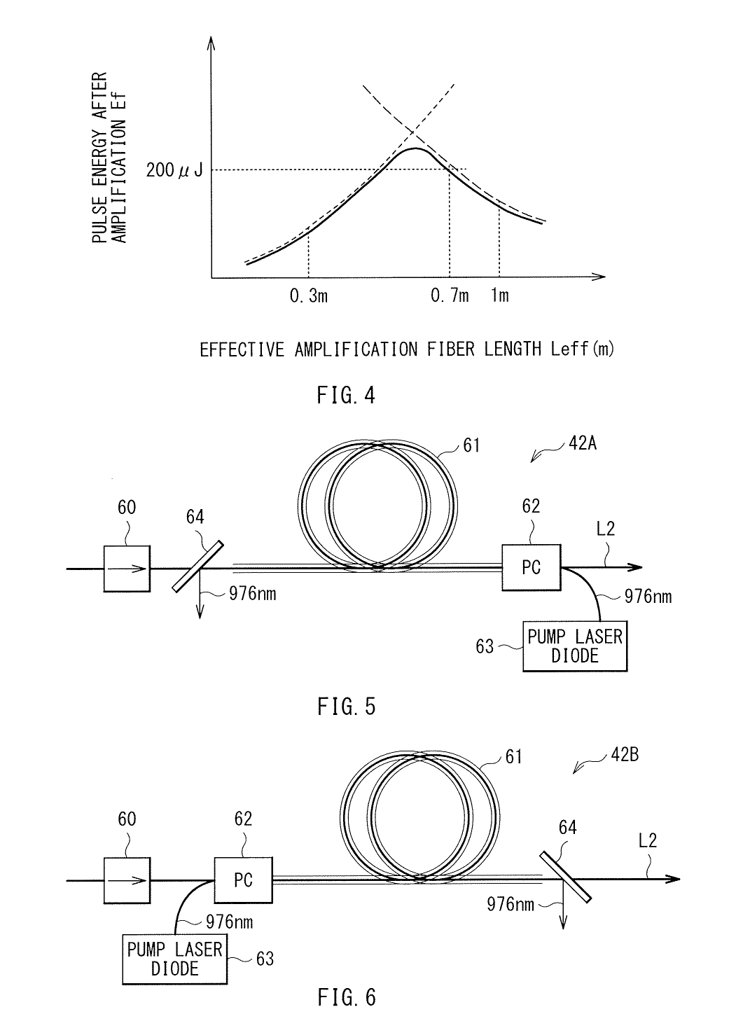

FIG. 4 illustrates a characteristic example of an Er fiber amplifier. The Er fiber amplifier may include a fused silica fiber with a fiber diameter of 25 μm doped with both Er and Yb. A horizontal axis may indicate the effective amplification fiber length Leff, and a vertical axis may indicate pulse energy Ef after amplification.

As the effective amplification fiber length Leff gradually increases from 0 m, the pulse energy Ef may gradually increase. When the effective amplification fiber length Leff is 0.3 m or more, the pulse energy Ef may reach a practical level. When the effective amplification fiber length Leff is a predetermined length from 0.3 m to 0.7 m both inclusive, the pulse energy Ef may reach a peak value. When the effective amplification fiber length Leff is longer than the predetermined length, stimulated brillouin scattering may occur, which may result in decrease in the pulse energy Ef. When the effective amplification fiber length Leff is 0.7 m, the pulse energy Ef may be 200 μJ, for example. Accordingly, the effective amplification fiber length Leff may be in a range from 0.3 m to 0.7 m both inclusive in a case where the fiber diameter is about 25 μm.

Threshold energy P_{SBS} at which stimulated brillouin scattering occurs may be represented by the following expression.

P_{SBS}˜Aeff/(K·g_{B}·Leff) (1)

where Aeff may be an effective mode cross-sectional area, K may be a polarization dependent factor, and g_{B} may be a brillouin gain coefficient. The longer the effective amplification fiber length Leff is and the smaller the effective mode cross-sectional area Aeff is, the more likely simulated brillouin scattering may be to occur. Herein, a parameter F may be defined as follows.

F=Aeff/Leff (2)

The smaller the parameter F is, the more likely stimulated brillouin scattering may be to occur. The effective mode cross-sectional area Aeff may be represented by the following expression, where D is a fiber diameter.

Aeff=π·(D/2)² (3)

Accordingly, the parameter F may be represented by the following expression.

F=π·(D/2)²/Leff (4)

In a case where the fiber diameter is about 25 μm, the effective amplification fiber length Leff is in a range from 0.3 m to 0.7 m both inclusive, which may correspond to the parameter F in a range from 0.7 nm to 1.64 nm both inclusive.

It is to be noted that, in addition to the above, the longer a pulse width of a pulsed laser light beam is, and the narrower a spectral line width of the pulsed laser light beam is, the more likely stimulated brillouin scattering may be to occur.

Herein, the laser diode 40 may correspond to a specific example of a “first oscillator” in any example embodiment of the present disclosure. The semiconductor optical amplifier 41 may correspond to a specific example of a “laser light generator” in any example embodiment of the present disclosure. The Er fiber amplifiers 53, 58, and 61 may correspond to a specific example of a “plurality of stages of fiber amplifiers” in any example embodiment of the present disclosure. The synchronous circuit 13 may correspond to a specific example of a “controller” in any example embodiment of the present disclosure.

### 3.2 Operation

A pulsed laser light beam outputted from the semiconductor optical amplifier 41 may enter the Er fiber amplifier 53 via the WDM optical coupler 52, and may be amplified by the Er fiber amplifier 53.

The pulsed laser light beam outputted from the Er fiber amplifier 53 may enter the Er fiber amplifier 58 via the isolator 54, the band-pass filter 55, and the pump combiner 57. The isolator 54 may prevent amplified spontaneous emission and return light from the Er fiber amplifiers 58 and 61. The band-pass filter 55 may prevent passage of the amplified spontaneous emission from the Er fiber amplifiers 53 and 58 to prevent self-oscillation. The pulsed laser light beam having entered the Er fiber amplifier 58 may be amplified by the Er fiber amplifier 58.

The pulsed laser light beam outputted from the Er fiber amplifier 58 may enter the Er fiber amplifier 61 via the band-pass filter 59 and the isolator 60. The band-pass filter 59 may prevent passage of amplified spontaneous emission from the Er fiber amplifiers 58 and 61 to prevent self-oscillation. The isolator 60 may prevent amplified spontaneous emission and return light from the Er fiber amplifier 61. The pulsed laser light beam having entered the Er fiber amplifier 61 may be amplified by the Er fiber amplifier 61 while preventing stimulated brillouin scattering.

### 3.3 Workings

The solid-state laser system 110 that includes the second solid-state laser unit 12 including the Er fiber amplifier system 42 according to the present embodiment, the first solid-state laser unit 11, and the wavelength conversion system 15 makes it possible to achieve a wavelength of 193.4 nm, a spectral line width Δv≦4 GHz, a pulse width from 1 ns to 30 ns both inclusive, and pulse energy of 167 μJ/pulse (1 W at 6 kHz).

Moreover, a pulsed laser light beam may be amplified while preventing stimulated brillouin scattering, which makes it possible to reduce a possibility of damage to the laser diode 40 by return light.

### 3.4 Modification Examples

### 3.4.1 First Modification Example

The Er fiber amplifier system 42 is not limited to the configuration illustrated in FIG. 3. For example, an Er fiber amplifier system 42A according to the present modification example may include a dichroic mirror 64, as illustrated in FIG. 5. FIG. 5 may illustrate a portion around the Er fiber amplifier 61 in a final stage in the Er fiber amplifier system 42A. The dichroic mirror 64 may be disposed between the isolator 60 and the Er fiber amplifier 61 in the final stage. The dichroic mirror 64 may be coated with a film that allows a pulsed laser light beam with a wavelength of about 1554 nm to pass therethrough at high transmittance and reflects pumping light with a wavelength of about 976 nm at high reflectivity. The dichroic mirror 64 may be so disposed as to allow a direction of normal to a reflection surface of the dichroic mirror 64 to be different from a direction of an optical path of the pulsed laser light beam with a wavelength of about 1554 nm.

Herein, the pump laser diode 63 may correspond to a specific example of a “second oscillator” in any example embodiment of the present disclosure. The pump combiner 62 may correspond to a specific example of a “first optical device” in any example embodiment of the present disclosure. The dichroic mirror 64 may correspond to a specific example of a “second optical device” in any example embodiment of the present disclosure.

The pumping light with a wavelength of about 976 nm outputted from the pump laser diode 63 may enter the Er fiber amplifier 61 from downstream of the Er fiber amplifier 61 by the pump combiner 62 to be excited. The pulsed laser light beam with a wavelength of about 1554 nm outputted from the Er fiber amplifier 58 previous to the Er fiber amplifier 61 and having entered the Er fiber amplifier 61 in the final stage may be amplified while preventing stimulated brillouin scattering. The remaining light of the pumping light having entered the Er fiber amplifier 61 by the pump combiner 62 may be reflected by the dichroic mirror 64 on upstream side of the Er fiber amplifier 61 to be outputted to outside of the optical path of the pulsed laser light beam with a wavelength of about 1554 nm.

In the Er fiber amplifier system 42A, increasing energy of the pumping light may cause further amplification of the pulsed laser light beam. At this occasion, the remaining pumping light not contributing to amplification of the pulsed laser light beam may be generated. The remaining pumping light may be outputted to outside of the optical path by the dichroic mirror 64 to prevent entry of the pumping light to the isolator 60. This makes it possible to increase longevity of the isolator 60.

It is to be noted that a pump combiner may be included in place of the dichroic mirror 64. The pump combiner may output pumping light with a wavelength of about 976 nm to outside of the optical path of a pulsed laser light beam with a wavelength of about 1554 nm.

Moreover, for example, as with an Er fiber amplifier system 42B illustrated in FIG. 6, the pump combiner 62 may be disposed between the isolator 60 and the Er fiber amplifier 61 in the final stage. The dichroic mirror 64 may be disposed in an optical path on downstream side of the Er fiber amplifier 61.

The pumping light with a wavelength of about 976 nm outputted from the pump laser diode 63 may enter the Er fiber amplifier 61 from upstream side of the Er fiber amplifier 61 by the pump combiner 62 to be excited. The remaining light of the pumping light with a wavelength of about 976 nm having entered the Er fiber amplifier 61 by the pump combiner 62 may be reflected by the dichroic mirror 64 on downstream side of the Er fiber amplifier 61 to be outputted to outside of the optical path of the pulsed laser light beam with a wavelength of about 1554 nm.

In the Er fiber amplifier system 42B, the remaining pumping light may be outputted to outside of the optical path by the dichroic mirror 64 to prevent entry of the pumping light to the wavelength conversion system 15, which makes it possible to reduce a possibility of damage to optical devices in the wavelength conversion system 15.

It is to be noted that even in this case, a pump combiner may be included in place of the dichroic mirror 64. The pump combiner may output the pumping light with a wavelength of about 976 nm to outside of the optical path of the pulsed laser light beam with a wavelength of about 1554 nm.

### 3.4.2 Second Modification Example

The Er fiber amplifier system 42 may supply pumping light to the Er fiber amplifier 61 by the pump combiner 62, as illustrated in FIG. 3, but is not limited to this configuration. For example, an Er fiber amplifier system 42C according to the present modification example may include a dichroic mirror 66, a light concentrating lens 67, and a collimator lens 68, as illustrated in FIG. 7. The dichroic mirror 66 may be coated with a film that allows a pulsed laser light beam with a wavelength of about 1554 nm to pass therethrough at high transmittance and reflects pumping light with a wavelength of about 976 nm at high reflectivity. The dichroic mirror 66, the light concentrating lens 67, and the collimator lens 68 may be configured to allow the pumping light with a wavelength of about 976 nm from the pump laser diode 63 to directly enter the Er fiber amplifier 61 from an end surface on downstream side of the Er fiber amplifier 61. The Er fiber amplifier system 42C may be of a so-called end-pumping type.

The Er fiber amplifier system 42C may further include a pump combiner 65. The pump combiner 65 may output the remaining light of the pumping light with a wavelength of about 976 nm to outside of the optical path of the pulsed laser light beam with a wavelength of about 1554 nm. The pump combiner 65 may be disposed between the isolator 60 and the Er fiber amplifier 61. It is to be noted that the dichroic mirror 64 may be included in place of the pump combiner 65 as with the Er fiber amplifier system 42A illustrated in FIG. 5.

Herein, the dichroic mirror 66 may correspond to a specific example of a “first optical device” in any example embodiment of the present disclosure. The pump combiner 65 may correspond to a specific example of a “second optical device” in any example embodiment of the present disclosure.

The pumping light with a wavelength of about 976 nm outputted from the pump laser diode 63 may be collimated by the collimator lens 68, and may be reflected by the dichroic mirror 66 at high reflectivity, and may be concentrated by the light concentrating lens 67. The pumping light concentrated by the light concentrating lens 67 may directly enter the Er fiber amplifier 61 from the end surface on downstream side of the Er fiber amplifier 61. The remaining light of the pumping light with a wavelength of about 976 nm having entered the Er fiber amplifier 61 by the dichroic mirror 66 and the light concentrating lens 67 may be outputted to outside of the optical path on upstream side of the Er fiber amplifier 61 by the pump combiner 65.

In the foregoing Er fiber amplifier system 42A, increasing energy of the pumping light may result in deterioration in the pump combiner 62. In contrast, in the Er fiber amplifier system 42C, unlike the Er fiber amplifier system 42A, the pump combiner 62 is not used, which makes it possible to increase longevity of the Er fiber amplifier system 42C.

Moreover, as with an Er fiber amplifier system 42D illustrated in FIG. 8, the dichroic mirror 66 and the light concentrating lens 67 may be disposed between the isolator 60 and the Er fiber amplifier 61. The dichroic mirror 66, the light concentrating lens 67, and the collimator lens 68 may be configured to allow the pumping light with a wavelength of about 976 nm from the pump laser diode 63 to directly enter the Er fiber amplifier 61 from the end surface on upstream side of the Er fiber amplifier 61.

In the Er fiber amplifier system 42D, the pump combiner 65 may be disposed in the optical path on downstream side of the Er fiber amplifier 61. It is to be noted that, as with the Er fiber amplifier system 42B illustrated in FIG. 6, the dichroic mirror 64 may be included in place of the pump combiner 65.

The pumping light concentrated by the light concentrating lens 67 may directly enter the Er fiber amplifier 61 from the end surface on upstream side of the Er fiber amplifier 61. The remaining light of the pumping light with a wavelength of about 976 nm having entered the Er fiber amplifier 61 by the dichroic mirror 66 and the light concentrating lens 67 may be outputted to outside of the optical path on downstream side of the Er fiber amplifier 61 by the pump combiner 65.

In the Er fiber amplifier system 42D, unlike the Er fiber amplifier system 42B, the pump combiner 62 is not used, which makes it possible to increase longevity of the Er fiber amplifier system 42D.

### 3.4.3 Third Modification Example

The number of stages of Er fiber amplifiers in the Er fiber amplifier system 42 is not limited to the number of stages illustrated in FIG. 3, and may be any number, as long as the number of stages is two or more. At least the parameter F in the Er fiber amplifier in the final stage of the plurality of stages of the Er fiber amplifiers may be in a range from 0.7 nm to 1.64 nm both inclusive.

### 3.4.4 Fourth Modification Example

The amplifier 2 is not limited to the configuration illustrated in FIG. 1. For example, an amplifier 2E including a chamber 47, an output coupling mirror 43, and high reflection mirrors 44 to 46 as illustrated in FIG. 9 may be adopted. Moreover, as with the amplifier 2 illustrated in FIG. 2, although not illustrated, the amplifier 2E may include the amplifier controller 30, the charger 31, the trigger corrector 32, and the pulsed power module 34 including the switch 33. The amplifier 2E may further include a high reflection mirror that guides the pulsed laser light beam LL from the solid-state laser system to the amplifier 2E, or may further include a high reflection mirror that guides a pulsed laser light beam outputted from the amplifier 2E to the exposure apparatus 4.

The chamber 47 may be provided with windows 49a and 49b. A pair of discharge electrodes 48 may be provided inside the chamber 47. The pair of discharge electrodes 48 may be so disposed as to face each other in a depth direction in FIG. 9. In the amplifier 2E, a ring optical resonator including the output coupling mirror 43 and the high reflection mirrors 44 to 46 may be configured. In the amplifier 2E, a pulsed laser light beam may repeatedly travel through the output coupling mirror 43, the high reflection mirror 44, a discharge space between the pair of discharge electrodes 48, the high reflection mirror 45, the high reflection mirror 46, and the discharge clearance between the pair of discharge electrodes 48 in this order to be amplified.

### 4. Second Embodiment

Next, description is given of a solid-state laser system including a solid-state laser apparatus according to a second embodiment of the present disclosure. Note that substantially same components as the components of the solid-state laser system 110 according to the foregoing comparative example are denoted by same reference numerals, and redundant description thereof is omitted.

### 4.1 Configuration

FIG. 10 schematically illustrates a configuration example of a solid-state laser system 70. The solid-state laser system 70 may include a second solid-state laser unit 71, a wavelength conversion system 75, and a high reflection mirror 92. The second solid-state laser unit 71 may include an Er fiber amplifier system 72.

FIG. 11 schematically illustrates a configuration example of the Er fiber amplifier system 72. The Er fiber amplifier system 72 may include two Er fiber amplifiers in a final stage, and may be configured to output two pulsed laser light beams L2 and L3 toward the wavelength conversion system 75. The Er fiber amplifier system 72 may include a beam splitter 73, a high reflection mirror 74, Er fiber amplifiers 69A and 69B, pump combiners 62A and 62B, and pump laser diodes 63A and 63B.

The beam splitter 73 may be disposed between the Er fiber amplifier 58 and the Er fiber amplifier 69A in an optical path of a pulsed laser light beam with a wavelength of about 1554 nm. The beam splitter 73 may be preferably disposed between the isolator 60 and the Er fiber amplifier 69A. The beam splitter 73 may be configured of a substrate coated with a film that allows a part of the pulsed laser light beam with a wavelength of about 1554 nm to pass therethrough at high transmittance and reflects the other part of the pulsed laser light beam at high reflectivity. The substrate may allow the pulsed laser light beam with a wavelength of about 1554 nm to pass therethrough at high transmittance. The film may be preferably so configured as to allow 50% of the pulsed laser light beam with a wavelength of about 1554 nm to pass therethrough and as to reflect 50% of the pulsed laser light beam.

The high reflection mirror 74 may be so disposed as to allow light reflected by the beam splitter 73 to enter the Er fiber amplifier 69B.

The Er fiber amplifier 69A may include a double-clad fiber (DCF) that is a silica fiber doped with both Er and Yb. The Er fiber amplifier 69A may be coupled to an optical fiber coupled to the pump laser diode 63A on downstream side by the pump combiner 62A. The pump combiner 62A may be configured to supply pumping light with a wavelength of about 976 nm outputted from the pump laser diode 63A to the Er fiber amplifier 69A. An effective amplification fiber length Leff of the Er fiber amplifier 69A may be in a range from 0.3 m to 0.7 m both inclusive, or may be any other length. Here, the effective amplification fiber length Leff represents a length of a portion where the pumping light passes of the Er fiber amplifier 69A. This applies to the Er fiber amplifier 69B, the pump combiner 62B, and the pump laser diode 63B as well.

The high reflection mirror 16 may be so disposed, as illustrated in FIG. 10, as to reflect the second pulsed laser light beam L2 outputted from the Er fiber amplifier 69A via the pump combiner 62A at high reflectivity, thereby allowing the thus-reflected second pulsed laser light beam L2 to enter the dichroic mirror 17.

The wavelength conversion system 75 may include a dichroic mirror 93. The dichroic mirror 93 may be coated with a film that allows a pulsed laser light beam with a wavelength of about 220.9 nm to pass therethrough at high transmittance and reflects a pulsed laser light beam with a wavelength of about 257.5 nm and a pulsed laser light beam with a wavelength of about 1554 nm at high reflectivity.

The high reflection mirror 92 may be so disposed as to reflect the third pulsed laser light beam L3 outputted from the Er fiber amplifier 69B via the pump combiner 62B at high reflectivity, thereby allowing the thus-reflected third pulsed laser light beam L3 to enter the dichroic mirror 93 of the wavelength conversion system 75.

Optical path lengths of two optical paths from the beam splitter 73 of the Er fiber amplifier system 72 to the dichroic mirror 93 of the wavelength conversion system 75 may be substantially equal to each other. A first optical path may be an optical path through the beam splitter 73, the Er fiber amplifier 69A, the high reflection mirror 16, the dichroic mirror 17, the CLBO crystal 18, and the dichroic mirror 93. A second optical path may be an optical path through the beam splitter 73, the high reflection mirror 74, the Er fiber amplifier 69B, the high reflection mirror 92, and the dichroic mirror 93.

Herein, the beam splitter 73 may correspond to a specific example of an “optical device” in a fiber amplifier system according to any example embodiment of the present disclosure. The Er fiber amplifier 69A may correspond to a specific example of a “first fiber amplifier” in any example embodiment of the present disclosure. The Er fiber amplifier 69B may correspond to a specific example of a “second fiber amplifier” in any example embodiment of the present disclosure. The Er fiber amplifiers 53 and 58 may correspond to a specific example of “one or more fifth fiber amplifiers” in any example embodiment of the present disclosure.

### 4.2 Operation

A pulsed laser light beam outputted from the Er fiber amplifier 58 via the band-pass filter 59 and the isolator 60 may be branched by the beam splitter 73. Light having passed through the beam splitter 73 may enter the Er fiber amplifier 69A, and may be amplified by the Er fiber amplifier 69A. Light reflected by the beam splitter 73 may enter the Er fiber amplifier 69B via the high reflection mirror 74, and may be amplified by the Er fiber amplifier 69B.

The second pulsed laser light beam L2 with a wavelength of about 1554 nm outputted from the Er fiber amplifier 69A may enter the CLBO crystal 18 together with the first pulsed laser light beam L1 with a wavelength of about 257.5 nm at a substantially coincidental timing. The CLBO crystal 18 may generate a pulsed laser light beam with a wavelength of about 220.9 nm corresponding to a sum frequency of a wavelength of about 257.5 nm and a wavelength of about 1554 nm. The CLBO crystal 18 may output three pulsed laser light beams, i.e., a pulsed laser light beam with a wavelength of about 257.5 nm, a pulsed laser light beam with a wavelength of about 1554 nm, and a pulsed laser light beam with a wavelength of about 220.9 nm.

The dichroic mirror 93 may allow the pulsed laser light beam with a wavelength of 220.9 nm of the three pulsed laser light beams outputted from the CLBO crystal 18 to pass therethrough at high transmittance and may reflect the pulsed laser light beam with a wavelength of about 257.5 nm and the pulsed laser light beam with a wavelength of about 1554 nm at high reflectivity.

Moreover, the third pulsed laser light beam L3 with a wavelength of about 1554 nm outputted from the Er fiber amplifier 69B may enter the dichroic mirror 93 via the high reflection mirror 92. The dichroic mirror 93 may reflect the third pulsed laser light beam L3 with a wavelength of about 1554 nm at high reflectivity. The third pulsed laser light beam L3 with a wavelength of about 1554 nm may enter the CLBO crystal 19 together with the pulsed laser light beam with a wavelength of about 220.9 nm having passed through the dichroic mirror 93 at a substantially coincidental timing.

Accordingly, the CLBO crystal 19 may generate the pulsed laser light beam LL with a wavelength of about 193.4 nm corresponding to a sum frequency of a wavelength of about 220.9 nm and a wavelength of about 1554 nm.

### 4.3 Workings

According to the solid-state laser system of the present embodiment, two Er fiber amplifiers 69A and 69B in the final stage may be provided to the Er fiber amplifier system 72. This makes it possible to increase total pulse energy of the second pulsed laser light beam L2 and the third pulsed laser light beam L3 outputted from the second solid-state laser unit 71 while preventing stimulated brillouin scattering, as compared with a case where only one Er fiber amplifier in the final stage is provided.

Moreover, the third pulsed laser light beam L3 outputted from the Er fiber amplifier 69B may enter the CLBO crystal 19 via the dichroic mirror 93. This makes it possible to increase pulse energy of the pulsed laser light beam with a wavelength of about 1554 nm entering the CLBO crystal 19. Accordingly, it is possible to increase pulse energy of the pulsed laser light beam LL with a wavelength of about 193.4 nm corresponding to the sum frequency.

### 4.4 Modification Examples

### 4.4.1 First Modification Example

In the solid-state laser system 70, the optical path of the pulsed laser light beam may be branched on downstream side of the Er fiber amplifier 58, as illustrated in FIGS. 10 and 11; however, the solid-state laser system 70 is not limited thereto. Alternatively, for example, the optical path may be branched on downstream side of the Er fiber amplifier 53 in a first stage. Moreover, as with a solid-state laser system 70A illustrated in FIGS. 12 and 13, the optical path may be branched on downstream side of the semiconductor optical amplifier 41. The solid-state laser system 70A may include a second solid-state laser unit 71A. The second solid-state laser unit 71A may include a beam splitter 76, a high reflection mirror 77, and Er fiber amplifier systems 78A and 78B.

The beam splitter 76 may be disposed between the semiconductor optical amplifier 41 and the Er fiber amplifier system 78A in an optical path of the pulsed laser light beam with a wavelength of about 1554 nm. The high reflection mirror 77 may be so disposed as to allow light reflected by the beam splitter 76 to enter the Er fiber amplifier system 78B.

Each of the Er fiber amplifier systems 78A and 78B may include the Er fiber amplifiers 53, 58, and 69, the isolators 54 and 60, and the band-pass filters 55 and 59. Each of the Er fiber amplifier systems 78A and 78B may further include the pump laser diodes 51, 56, and 63, the WDM optical coupler 52, and the pump combiners 57 and 62. The Er fiber amplifier 69 in the final stage may include a double-clad fiber that is a silica fiber doped with both Er and Yb. The effective amplification fiber length Leff of the Er fiber amplifier 69 may be in a range from 0.3 m to 0.7 m both inclusive, or may be any other length. Here, the effective amplification fiber length Leff represents a length of a portion where the pumping light passes of the Er fiber amplifier 69.

Herein, the beam splitter 76 may correspond to a specific example of an “optical device” in a fiber amplifier system of any example embodiment of the present disclosure. The Er fiber amplifier 69 of the Er fiber amplifier system 78A may correspond to a specific example of a “first fiber amplifier” in any example embodiment of the present disclosure. The Er fiber amplifier 69 of the Er fiber amplifier system 78B may correspond to a specific example of a “second fiber amplifier” in any example embodiment of the present disclosure. The Er fiber amplifiers 53 and 58 of the Er fiber amplifier system 78A may correspond to a specific example of “one or more third fiber amplifiers” in any example embodiment of the present disclosure. The Er fiber amplifiers 53 and 58 of the Er fiber amplifier system 78B may correspond to a specific example of “one or more fourth fiber amplifiers” in any example embodiment of the present disclosure.

The pulsed laser light beam outputted from the semiconductor optical amplifier 41 may be branched by the beam splitter 76. Light having passed through the beam splitter 76 may enter the Er fiber amplifier system 78A, and may be amplified by the Er fiber amplifier system 78A. Light reflected by the beam splitter 76 may enter the Er fiber amplifier system 78B via the high reflection mirror 77, and may be amplified by the Er fiber amplifier system 78B. Subsequent operations may be similar to those in the solid-state laser system 70.

### 4.4.2 Second Modification Example

In the solid-state laser system 70, the optical path of the pulsed laser light beam may be branched, as illustrated in FIGS. 10 and 11; however, the solid-state laser system 70 is not limited thereto. Alternatively, as with a solid-state laser system 70B illustrated in FIG. 14, for example, two systems, i.e., a system that generates the second pulsed laser light beam L2 and a system that generates the third pulsed laser light beam L3 may be provided. The solid-state laser system 70B may include a second solid-state laser unit 71B and a synchronous circuit 83.

The second solid-state laser unit 71B may include laser diodes 40A and 40B, semiconductor optical amplifiers 41A and 41B, and the Er fiber amplifier systems 78A and 78B. The laser diodes 40A and 40B may be similar to the laser diode 40. The semiconductor optical amplifiers 41A and 41B may be similar to the semiconductor optical amplifier 41.

The synchronous circuit 83 may be configured to output a predetermined trigger signal to each of the semiconductor optical amplifier 23 of the first solid-state laser unit 11, and the semiconductor optical amplifiers 41A and 41B of the second solid-state laser unit 71B on the basis of the trigger signal Tr1

Herein, the Er fiber amplifiers 53, 58, and 69 of the Er fiber amplifier system 78A may correspond to a specific example of a “first plurality of stages of fiber amplifiers” in any example embodiment of the present disclosure. The Er fiber amplifiers 53, 58, and 69 of the Er fiber amplifier system 78B may correspond to a specific example of a “second plurality of stages of fiber amplifiers” in any example embodiment of the present disclosure. The CLBO crystal 18 may correspond to a specific example of a “first wavelength converter” in any example embodiment of the present disclosure. The CLBO crystal 19 may correspond to a specific example of a “second wavelength converter” in any example embodiment of the present disclosure.

In the second solid-state laser unit 71B, the laser diode 40A may output CW-oscillated light or pulse-oscillated light with a wavelength of about 1554 nm as seed light. The semiconductor optical amplifier 41A may convert the seed light into a pulsed laser light beam with a predetermined pulse width on the basis of a predetermined trigger signal from the synchronous circuit 83 and amplify the pulsed laser light beam. The pulsed laser light beam outputted from the semiconductor optical amplifier 41A may enter the Er fiber amplifier system 78A, and may be amplified by the Er fiber amplifier system 78A. Thus, the Er fiber amplifier system 78A may output the second pulsed laser light beam L2 with a wavelength of about 1554 nm.

The foregoing operation is applied to the laser diode 40B, the semiconductor optical amplifier 41B, and the Er fiber amplifier system 78B. Thereafter, Er fiber amplifier system 78B may output the third pulsed laser light beam L3 with a wavelength of about 1554 nm.

The synchronous circuit 83 may supply a trigger signal with a predetermined pulse width to each of the semiconductor optical amplifiers 23, 41A, and 41B at a predetermined timing on the basis of the trigger signal Tr1. The predetermined timing may be so adjusted as to allow the first pulsed laser light beam L1, the second pulsed laser light beam L2, and the third pulsed laser light beam L3 to enter the CLBO crystal 18 of the wavelength conversion system 75 at a substantially coincidental timing. The predetermined pulse width may be so adjusted as to allow the pulse width of the pulsed laser light beam LL, which is to be outputted from the solid-state laser system 70B, to fall in a range from 1 nsec to 30 nsec both inclusive.

Subsequent operations may be similar to those in the solid-state laser system 70.

In the solid-state laser system 70B, total pulse energy of the second and third pulsed laser light beams L2 and L3 outputted from the second solid-state laser unit 71B may be, for example, about twice as large as that in the second solid-state laser unit 120 according to the comparative example illustrated in FIG. 1. Moreover, the synchronous circuit 83 may perform timing control of the semiconductor optical amplifier 41B to control timings of pulsed laser light beams entering the CLBO crystal 18 at high accuracy. This makes it possible to increase pulse energy of the pulsed laser light beam LL to be outputted from the solid-state laser system 70B.

### 5. Hardware Environment of Controller

A person skilled in the art will appreciate that a general-purpose computer or a programmable controller may be combined with a program module or a software application to execute any subject matter disclosed herein. The program module, in general, may include one or more of a routine, a program, a component, a data structure, and so forth that each causes any process described in any example embodiment of the present disclosure to be executed.

FIG. 15 is a block diagram illustrating an exemplary hardware environment in which various aspects of any subject matter disclosed therein may be executed. An exemplary hardware environment 100 in FIG. 15 may include a processing unit 1000, a storage unit 1005, a user interface 1010, a parallel input/output (I/O) controller 1020, a serial I/O controller 1030, and an analog-to-digital (A/D) and digital-to-analog (D/A) converter 1040. Note that the configuration of the hardware environment 100 is not limited thereto.

The processing unit 1000 may include a central processing unit (CPU) 1001, a memory 1002, a timer 1003, and a graphics processing unit (GPU) 1004. The memory 1002 may include a random access memory (RAM) and a read only memory (ROM). The CPU 1001 may be any commercially-available processor. A dual microprocessor or any other multi-processor architecture may be used as the CPU 1001.

The components illustrated in FIG. 15 may be coupled to one another to execute any process described in any example embodiment of the present disclosure.

Upon operation, the processing unit 1000 may load programs stored in the storage unit 1005 to execute the loaded programs. The processing unit 1000 may read data from the storage unit 1005 together with the programs, and may write data in the storage unit 1005. The CPU 1001 may execute the programs loaded from the storage unit 1005. The memory 1002 may be a work area in which programs to be executed by the CPU 1001 and data to be used for operation of the CPU 1001 are held temporarily. The timer 1003 may measure time intervals to output a result of the measurement to the CPU 1001 in accordance with the execution of the programs.

The GPU 1004 may process image data in accordance with the programs loaded from the storage unit 1005, and may output the processed image data to the CPU 1001.

The parallel I/O controller 1020 may be coupled to parallel I/O devices operable to perform communication with the processing unit 1000, and may control the communication performed between the processing unit 1000 and the parallel I/O devices. Non-limiting examples of the parallel I/O devices may include the laser controller 3, the synchronization controller 6, the synchronous circuits 13 and 83, the amplifier controller 30, and the charger 31. The serial I/O controller 1030 may be coupled to a plurality of serial I/O devices operable to perform communication with the processing unit 1000, and may control the communication performed between the processing unit 1000 and the serial I/O devices. Non-limiting examples of serial I/O devices may include the laser controller 3, the exposure apparatus controller 5, the synchronization controller 6, and the synchronous circuits 13 and 83. The A/D and D/A converter 1040 may be coupled to various kinds of sensors and analog devices through respective analog ports. Non-limiting examples of the analog devices may include the semiconductor optical amplifiers 23, 41, 41A and 41B. The A/D and D/A converter 1040 may control communication performed between the processing unit 1000 and the analog devices, and may perform analog-to-digital conversion and digital-to-analog conversion of contents of the communication.

The user interface 1010 may provide an operator with display showing a progress of the execution of the programs executed by the processing unit 1000, such that the operator is able to instruct the processing unit 1000 to stop execution of the programs or to execute an interruption routine.

The exemplary hardware environment 100 may be applied to one or more of configurations of the laser controller 3 and other controllers according to any example embodiment of the present disclosure. A person skilled in the art will appreciate that such controllers may be executed in a distributed computing environment, namely, in an environment where tasks may be performed by processing units linked through any communication network. In any example embodiment of the present disclosure, unillustrated controllers used for an exposure apparatus laser that integrally control controllers such as the laser controller 3 may be coupled to one another through a communication network such as Ethernet (Registered Trademark) or the Internet. In the distributed computing environment, the program module may be stored in each of local and remote memory storage devices.

### 6. Et Cetera

The foregoing description is intended to be merely illustrative rather than limiting. It should therefore be appreciated that variations may be made in example embodiments of the present disclosure by persons skilled in the art without departing from the scope as defined by the appended claims.

The terms used throughout the specification and the appended claims are to be construed as “open-ended” terms. For example, the term “include” and its grammatical variants are intended to be non-limiting, such that recitation of items in a list is not to the exclusion of other like items that can be substituted or added to the listed items. The term “have” and its grammatical variants are intended to be non-limiting, such that recitation of items in a list is not to the exclusion of other like items that can be substituted or added to the listed items. Also, the singular forms “a”, “an”, and “the” used in the specification and the appended claims include plural references unless expressly and unequivocally limited to one referent.

What is claimed is:

1. A solid-state laser apparatus, comprising:
a first oscillator configured to output seed light;
a laser light generator configured to output a pulsed laser light beam generated on a basis of the seed light; and
a plurality of stages of fiber amplifiers disposed in series in an optical path of the pulsed laser light beam, and including a final stage fiber amplifier, the final stage fiber amplifier being located in a final stage in the plurality of stages of fiber amplifiers, and including a silica fiber doped with erbium and ytterbium,
a value as a result of division of a cross-sectional area of the silica fiber by a fiber length of the silica fiber being in a range from 0.7 nm to 1.64 nm both inclusive.

2. The solid-state laser apparatus according to claim 1, wherein the plurality of stages of fiber amplifiers are configured as three stages of fiber amplifiers.

3. The solid-state laser apparatus according to claim 1, wherein
a fiber diameter of the silica fiber is about 25 μm, and
the fiber length of the silica fiber is in a range from 0.3 meters to 0.7 meters both inclusive.

4. The solid-state laser apparatus according to claim 1, further comprising a controller configured to control the laser light generator to allow a pulse width of the pulsed laser light beam outputted from the final stage fiber amplifier to fall in a range from 1 nsec to 30 nsec both inclusive.

5. The solid-state laser apparatus according to claim 1, further comprising:
a second oscillator configured to output pumping light with a wavelength different from a wavelength of the pulsed laser light beam;
a first optical device disposed in the optical path of the pulsed laser light beam, and configured to guide the pumping light to the silica fiber; and
a second optical device disposed in the optical path of the pulsed laser light beam, and configured to guide the pumping light to outside of the optical path of the pulsed laser light beam.

6. The solid-state laser apparatus according to claim 5, wherein the first optical device is provided upstream of the second optical device in the optical path of the pulsed laser light beam.

7. The solid-state laser apparatus according to claim 5, wherein the first optical device is provided downstream of the second optical device in the optical path of the pulsed laser light beam.

8. The solid-state laser apparatus according to claim 5, wherein the first optical device includes a dichroic mirror disposed to allow a direction of normal to a reflection surface of the dichroic mirror to be different from a direction of the optical path of the pulsed laser light beam.

9. The solid-state laser apparatus according to claim 5, wherein the first optical device includes a pump combiner.

10. The solid-state laser apparatus according to claim 5, wherein the second optical device includes a dichroic mirror disposed to allow a direction of normal to a reflection surface of the dichroic mirror to be different from a direction of the optical path of the pulsed laser light beam.

11. The solid-state laser apparatus according to claim 5, wherein the second optical device includes a pump combiner.

12. A fiber amplifier system, comprising:
an optical device configured to cause a first optical path of a pulsed laser light beam to be branched into a second optical path and a third optical path;
a first fiber amplifier disposed in the second optical path; and
a second fiber amplifier disposed in the third optical path.

13. The fiber amplifier system according to claim 12, further comprising:
one or more third fiber amplifiers provided upstream of the first fiber amplifier in the second optical path; and
one or more fourth fiber amplifiers provided upstream of the second fiber amplifier in the third optical path.

14. The fiber amplifier system according to claim 12, further comprising one or more fifth fiber amplifiers provided in the first optical path.

15. A solid-state laser system, comprising:
a first solid-state laser unit configured to output a first pulsed laser light beam with a first wavelength;
a second solid-state laser unit including a first plurality of stages of fiber amplifiers and a second plurality of stages of fiber amplifiers, the first plurality of stages of fiber amplifiers being disposed in series and configured to output a second pulsed laser light beam with a second wavelength, and the second plurality of stages of fiber amplifiers being disposed in series and configured to output a third pulsed laser light beam with the second wavelength;
a first wavelength converter configured to receive the first pulsed laser light beam and the second pulsed laser light beam, and output a fourth pulsed laser light beam with a third wavelength that is converted from the first wavelength and the second wavelength; and
a second wavelength converter configured to receive the third pulsed laser light beam and the fourth pulsed laser light beam, and output a fifth pulsed laser light beam with a fourth wavelength that is converted from the second wavelength and the third wavelength.

16. The solid-state laser system according to claim 15, wherein
a final stage fiber amplifier among the first plurality of stages of fiber amplifiers includes a silica fiber doped with erbium and ytterbium, and
a value as a result of division of a cross-sectional area of the silica fiber by a fiber length of the silica fiber is in a range from 0.7 nm to 1.64 nm both inclusive.

17. The solid-state laser system according to claim 15, wherein
a final stage fiber amplifier among the second plurality of stages of fiber amplifiers includes a silica fiber doped with erbium and ytterbium, and
a value as a result of division of a cross-sectional area of the silica fiber by a fiber length of the silica fiber is in a range from 0.7 nm to 1.64 nm both inclusive.
